(19) United States
(12) Patent Application Publication
(10) Pub. No.: US 2016/0115398 A1
(43) Pub. Date: Apr. 28, 2016

(54) HYDROTREATING CATALYST, PROCESS FOR PREPARING THE SAME AND USE THEREOF

(71) Applicant: INDIAN OIL CORPORATION LIMITED, Mumbai (IN)

(72) Inventors: Muniaswamy RAJESH, Faridabad (IN); Madhusudan SAU, Faridabad (IN); Balam Harish KUMAR, Faridabad (IN); Brijesh KUMAR, Faridabad (IN); Santanam RAJAGOPAL, Faridabad (IN); Ravinder Kumar MALHOTRA, Faridabad (IN); Durlubh Kumar SHARMA, Faridabad (IN); Jayaraj CHRISTOPHER, Faridabad (IN)

(21) Appl. No.: 14/650,272

(22) PCT Filed: Dec. 5, 2013
(86) PCT No.: PCT/IB2013/060663

§ 371 Date: Jun. 5, 2015

(30) Foreign Application Priority Data
Dec. 7, 2012 (IN) 2603/MUM/2012

(51) Int. Cl. C10G 65/00; C10G 45/08; B01J 35/10; B01J 23/882; B01J 37/02; B01J 37/08; C10G 3/00; C10G 45/50

(52) U.S. Cl. CPC C10G 65/00; C10G 3/50; C10G 3/48; C10G 45/08; C10G 45/50; B01J 23/882; B01J 37/0201; B01J 37/0236; B01J 37/08; B01J 35/1014; B01J 35/1019; B01J 35/1038; B01J 35/1042; B01J 35/1061; B01J 35/1066

(57) ABSTRACT

The present invention relates to a hydrotreating catalyst and more particularly to a catalyst comprising of Group VIB and Group VIII metals impregnated on non-refractory oxide as a catalyst support and process for preparing and its use thereof.

### FIELD OF THE INVENTION

The present invention relates to a hydrotreating catalyst. More particularly the catalyst of present invention comprises of Group VIB and Group VIII metals impregnated on non-refractory oxide as a catalyst support and process for preparing and its use thereof.

### BACKGROUND OF THE INVENTION

Globally, there is an increasing demand for biofuels as an alternative to diesel fuel, due to environmental reasons. Biofuel such as biodiesel are made from non-edible oils such as Jatropha, Karanjia, rubber seed oil, cotton seed oil, waste restaurant oil, etc. Chemically, these oils have similar triglyceride structure with different fatty acid composition. Cleavage of carbon-oxygen bonds from these oils can produce high quality (with respect to Cetane number) diesel range components which are fully compatible with conventional diesel produced from crude oil refining.

Many processes such as transesterification, enzyme hydrolysis, supercritical methanol, hydrotreating, etc. exists to produce biodiesel from vegetable oil in which hydrotreating is one of the important processes being used in refineries mainly to produce low sulphur diesel from gas oil feed stocks to meet diesel fuel specification. Hydrotreating catalysts comprise of a carrier (also referred as catalyst support) wherein metals from Group VIB and Group VIII are impregnated. Major catalyst support materials being employed for hydrotreating of gas oil are alumina, silica, silica-alumina, magnesia, zirconia, titania as well as mixtures thereof. Such conventional catalyst systems are being used in refineries for hydrotreating of different streams produced from refining of petroleum or Oil derived from Coal. The physical characteristics of feed stock such as viscosity, metals, molecular size and boiling range has a lot of impact for choosing hydrotreating catalysts for particular application. It has been well established that hydrotreating catalyst systems are working well with feed stocks containing low amount of metal content and trace amount of oxygen content.

Non-edible oil generally contains 10-12% wt of oxygen and metals (sodium, potassium, calcium, iron, magnesium, etc.) in the range of 100-500 ppm. These metals in vegetable oils are to be removed prior to processing in hydrotreating.

Hydrotreating catalysts are generally comprises metals such as Molybdenum, Cobalt or Nickel supported on Alumina.

Over the years, hydroprocessing catalysts are exclusively being developed for dealing with the elimination of sulphur and nitrogen hetero atoms from petroleum streams and presently researchers are using the same for conversion of highly oxygen rich high molecular weight vegetable oil into fuels, which might affect catalyst life. Since vegetable oil are bulky in nature in comparison to gas oil molecules which therefore need wide range of pores on the support systems to process bulky molecules. The major problem associated with hydrotreating of vegetable oil is its high coke formation tendency, which leads to blockage of catalyst active sites. Therefore, support for the preparation of catalyst should have high surface area in order to accommodate catalyst particles very well along with varying pore size distribution essentially consists of micro and meso pore range which helps the bulky vegetable oil molecules can easily move within the catalyst systems, along with less prone to coke formation would be preferred. Therefore, there is a continuing need in the art of making new catalyst systems which can perform better for hydrodesulphurization and also are capable of eliminating simultaneously oxygen and sulphur.

In light of the above mentioned prior arts, there is a need to provide for an improved catalyst which is more suited for preparing diesel-range hydrocarbons from feed comprising vegetable oils. Also, there is a need to provide for a process for preparation of the aforesaid catalyst. Also, there is a need to provide for a method of producing diesel-range hydrocarbons from vegetable oils using the aforesaid catalyst.

### SUMMARY OF THE INVENTION

Accordingly, the present invention provides a hydrotreating catalyst comprising:
a non-refractory oxide as a catalyst support;
a Group VIB metal impregnated on the support; and
a Group VIII metal impregnated on the support;
   characterized in that:
the support comprises porous activated carbon;
an amount of Group VIB metal impregnated on the support is in the range of 10 to 18 wt % based on a total weight of the finished catalyst composition; and
an amount of Group VIII metal impregnated on the support is in the range of 0.1 to 5.0 wt % based on a total weight of the finished catalyst composition.

In another aspect the present invention provides a process for preparing a hydrotreating catalyst, said process comprising the steps of:
impregnating a non-refractory oxide catalyst support with an aqueous solution comprising a source of Group VIB metal and a source of Group VIII metal to obtain wet impregnated support;
drying the wet-impregnated support for about 1 to 5 hours at a temperature in the range of about 100 to 120° C. to obtain impregnated support; and
calcining the impregnated support at a temperature in the range of about 500 to 600° C. for a time period in the range of about 1 to 5 hours to obtain the hydrotreating catalyst;
   characterized in that:
the support comprises porous activated carbon;
an amount of Group VIB metal source present in the aqueous solution is such that 10 to 18 wt % of the Group VIB metal based on a total weight of the finished catalyst composition is incorporated in the support; and
an amount of Group VIII metal source present in the aqueous solution is such that 0.1 to 5.0 wt % of the Group VIII metal based on a total weight of the finished catalyst composition is incorporated in the support.

In yet another aspect the present invention provides a process for producing diesel range hydrocarbons from a feed comprising vegetable oil and or vegetable oil with gas oil, said process comprising the steps of:
a. contacting the feed within a hydrotreatment reaction zone with a gas comprising hydrogen under hydrotreatment conditions in presence of a hydrotreating catalyst comprising a non-refractory oxide catalyst support, a Group VIB metal impregnated on the support and a Group VIII metal impregnated on the support;
b. removing a hydrotreated product stream; and
c. separating diesel range hydrocarbons from the hydrotreated product stream
   characterized in that:
the support comprises porous activated carbon;
an amount of Group VIB metal impregnated on the support is in the range of 10 to 18 wt % based on a total weight of the finished catalyst composition; and
an amount of Group VIII metal impregnated on the support is in the range of 0.1 to 5.0 wt % based on a total weight of the finished catalyst composition.

Various objects, features, aspects, and advantages of the present invention will become more apparent from the following detailed description of preferred embodiments of the invention.

### DESCRIPTION OF THE INVENTION

The present invention now will be described more fully hereinafter. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present invention pertains to a catalyst composition for preparing diesel-range hydrocarbons from feed comprising vegetable oil, a process for preparing the same and its use thereof in producing diesel-range hydrocarbons.

According to the present invention the catalyst is a hydrotreating catalyst, wherein the metals are impregnated on a non-refractory oxide catalyst support. The catalyst herein comprises a Group VIB metal such as Molybdenum and a Group VIII metal such as Cobalt or Nickel being impregnated on a support. The support according to the invention is porous activated carbon.

According to the invention, the catalyst composition is having Group VIB metal content in the range of about 10-18 wt % and Group VIII metal content of about 0.1 to 5.0 wt % based on the total weight of the finished catalyst composition.

In a preferred embodiment, the Group VIB metal is Molybdenum. In yet another preferred embodiment the Group VIII metal is selected Cobalt or Nickel. The catalyst of the present invention may further comprise a Group element impregnated on the support. In case the catalyst comprises Group IIIA element, the same may be preferably chosen as phosphorous and can be present in the range of about 0.1 to 5.0 wt % based on the total weight of the finished catalyst composition. In a particular embodiment, when the catalyst comprises Nickel impregnated on the support along with Molybdenum, the catalyst does not contain any added Group IIIA element and/or Group VA element. In still another preferred aspect of the invention, an amount of porous activated carbon is in the range of about 70-85 wt % based on the total weight of the finished catalyst composition.

The catalyst has a BET surface area in the range of about 50 to 300 m²/g; average pore diameter of 12 to 100 Å; and pore volume in the range of 0.3 to 1.4 cc/g

Further the present invention provides a process for preparing the hydrotreating catalyst comprising the steps of:
(a) impregnating a non-refractory oxide catalyst support with an aqueous solution comprising a source of Group VIB metal and a source of Group VIII metal to obtain wet impregnated support;
(b) drying the wet-impregnated support for about 1 to 5 hours at a temperature in the range of about 100 to 120° C. to obtain impregnated support; and
(c) calcining the impregnated support at a temperature in the range of about 500 to 600° C. for a time period in the range of about 1 to 5 hours to obtain the hydrotreating catalyst.

The amount of Group VIB metal source, the Group VIB metal being preferably Molybdenum, present in the aqueous solution is such that 10 to 18 wt % of the Group VIB metal based on a total weight of the finished catalyst composition is incorporated in the support and the amount of Group VIII metal source, the Group VIII metal being preferably Cobalt or Nickel, present in the aqueous solution is such that 0.1 to 5.0 wt % of the Group VIII metal based on a total weight of the finished catalyst composition is incorporated in the support.

According to an embodiment, ammonium hepta molybdate may be chosen as source of molybdenum. According to an embodiment, cobalt nitrate hexahydrate may be chosen as cobalt source. According to another embodiment, Nickel nitrate hexahydrate may be chosen as Nickel source.

According to an embodiment, the aqueous solution further comprises a Group IIIA element source. An amount of Group IIIA element source present in the aqueous solution is such that 0.1 to 5.0 of the Group IIIA element based on a total weight of the finished catalyst composition is incorporated in the support. The Group IIIA element in a preferred aspect of the invention is Phosphorous. In a preferred aspect, the Group IIIA element source also acts as Group VIB metal source and is Phosphomolybdic acid.

In a preferred aspect of the invention, the porous activated carbon has BET surface area in the range of 500 to 1500 (1500 m²/g; Bulk density in the range of 0.3 to 0.7 g/cc; average pore diameter in the range of 12 to 100 Å; and Pore volume in the range of 0.3 to 1.4 cc/g.

Further, the present invention provides a process for producing diesel range hydrocarbons from a feed comprising vegetable oil and or vegetable oil with gas oil, said process comprising the steps of:
a. contacting the feed within a hydrotreatment reaction zone with a gas comprising hydrogen under hydrotreatment conditions in presence of a hydrotreating catalyst comprising a non-refractory oxide catalyst support, a Group VIB metal impregnated on the support and a Group VIII metal impregnated on the support;
b. removing a hydrotreated product stream; and
c. separating diesel range hydrocarbons from the hydrotreated product stream.

In an embodiment, the vegetable oil is selected from a group comprising of Jatropha Oil, Karanjia Oil, Rubber seed oil, Cotton Seed oil, waste restaurant oil and or mixtures thereof. In a preferred aspect, the feed comprises a mixture of vegetable oil and gas oil with up to about 20 wt % vegetable oil.

In the process described above, the hydrotreatment in step (a) is carried out at a temperature from about 350° C. to about 400° C. The hydrotreatment reaction zone has an LHSV (Liquid Hour Space Velocity) from 0.5 hr⁻¹ to 2 hr⁻¹ a hydrogen partial pressure from about 60 bar to about 120 bar. Also, hydrotreatment reaction zone has H₂ gas to feed ratio from about 400 Nm³/m³ to 600 Nm³/m³.

It has been observed that the catalyst provided in the present invention removes oxygen from vegetable oils, removes sulphur from various petroleum feed stocks, more preferably enables deep desulphurization and aromatic saturation of neat gas oil and also simultaneously functions in hydrodesulphurization and hydrodeoxygenation of blended feed stocks such as mixture of vegetable oil and high sulphur gas oil. Accordingly, the catalyst of the present invention is used to convert feedstocks into diesel range hydrocarbons with high Cetane index and low density.

The performance of the catalyst is evaluated for simultaneous functions of hydrodesulphurization, hydrodearomatization and hydrodeoxygenation of feed stock. In accordance with the present invention the catalyst results in more than 99% sulphur reduction in neat gas oil. In accordance with the present invention the catalyst results in 100% oxygen removal from vegetable oil such as Jatropha oil.

In accordance with the present invention the catalyst simultaneously removes sulphur more than 99% and oxygen 100% from composite feed containing vegetable oil up to 20 wt %.

According to the invention, before being used in hydrotreating, the catalyst is presulfided to convert the metal oxides into corresponding metal sulphides using Dimethyl disulphide (DMDS) as sulfiding agent.

The additional by products such as CO₂, H₂O, CO formed during vegetable oil co-processing with gas oil by hydrotreating, in addition to H₂S and NH₃, does not alter the catalyst activity in the duration of study with respect to sulphur and oxygen removal efficiency. Further, the hydrotreated diesel is been less prone to rancidification than biodiesel produced from transesterification of vegetable oil.

Following example further illustrates the present invention without limiting the scope of the invention:

### EXAMPLE 1

### Process for Preparing Catalyst having Cobalt and Molybdenum Impregnated on Activated Carbon

Activated carbon having a BET surface area at least about 1100 m²/g was obtained from commercial sources. The catalyst support was employed in the form of extrudates. Molybdenum source i.e. Phosphomolybdic acid was dissolved in distilled water was added to carbon support. This mixture was slowly stirred for 1 hr at room temperature. To this, aqueous solution of cobalt nitrate hexahydrate was added and stirring continued slowly for 12 hrs. After stirring was over, the resultant solution was slowly evaporated on a hot plate at 80° C. with heating rate of 0.3° C./minute. After that it was kept in an oven for 12 hrs at 110° C. with heating rate of 0.3° C./minute. Subsequently, the material was taken in platinum crucible covered with lid, calcined at 500° C. for 1 hr in an inert atmosphere. The resultant material was kept in muffle furnace at 350° C. for 2 hrs to obtain the final catalyst. XRD spectra of the catalyst have shown that the active species of the catalyst was obtained in the form of CoMoO₄/CoMoO₃.The detail of this catalyst is given below in Table 1. Surface area of the final catalyst was found to be 223 m²/g. The catalyst thus prepared was sulphided in situ in order to convert metal oxides into metal sulphides by any known sulphidation method in the art, such as passing a mixture of Dimethyl disulphide dissolved in any gas oil in presence of hydrogen gas over the catalyst at elevated temperature up to, but not limited to 400° C. at high hydrogen partial pressure for 2-24 hrs, say 5 hrs.

The performance of the catalyst prepared in example 1 after sulphidation was studied for hydrotreating of neat gas oil (Example 2) neat Jatropha oil (Example 3) and Jatropha oil blended with gas oil (Example 4).

TABLE 1
Final Catalyst properties

| | |
|---|---|
| Support material | Activated carbon |
| Active metals | Molybdenum, Cobalt |
| BET Surface area, m²/g | 223 |
| Catalyst shape | Cylindrical |
| Active species | CoMoO₄/CoMoO₃ |
| Approximate catalyst | Cobalt 0.5 wt % |
| composition | Molybdenum 13 wt % |

Note:
BET stands for Brunauer, Emmet, Teller

### EXAMPLE 2

### Catalyst Performance in Neat Gas Oil

Neat gas oil was hydrotreated using the catalyst prepared in Example 1 above. The operating conditions included H₂ partial pressure: 90 bar, Temperature: 370° C., LHSV: 1 hr⁻¹ and Gas to Oil ratio: 500 Nm³/m³. The results of the same are given in table 2.

TABLE 2
Properties of Feed gas oil and hydrotreated gas oil product

| | Feed (Gas oil) | Hydrotreated Product |
|---|---|---|
| Specific Gravity | 0.8452 | 0.8146 |
| Sulphur, ppm | 13,600 | 30 |
| Nitrogen, ppm | 106 | 1 |
| Cetane Index | 51.5 | 62.4 |

ASTM D-86 (% Vol. vs. Temp(° C.)

| | | |
|---|---|---|
| IBP (Initial Boiling Point) | 182 | 137 |
| 5 | 213 | 176 |
| 10 | 230 | 198 |
| 20 | 253 | 227 |
| 30 | 267 | 248 |
| 40 | 279 | 261 |
| 50 | 289 | 273 |
| 60 | 300 | 284 |
| 70 | 312 | 297 |
| 80 | 326 | 312 |
| 90 | 345 | 333 |
| 95 | 363 | 353 |
| FBP(Final Boiling Point) | 374 | 362 |

It has been found that the performance of the developed catalyst for hydrotreating of gas oil under the said reaction conditions is found to meeting the diesel product specifications.

### EXAMPLE 3

### Catalyst Performance in Neat Non-Edible Oil (Jatropha)

Further, experiments have been conducted with neat non-edible oil (Jatropha) using the developed catalyst of example 1. The operating conditions included partial pressure: 90 bar, Temperature: 370° C., LHSV: 1 hr⁻¹ and Gas to Oil ratio: 500 Nm³/m³. The results are shown in table 3.

TABLE 3
Properties of neat Jatropha oil and
product of hydrotreated Jatropha oil

| | Feed (Jatropha Oil) | Hydrotreated product |
|---|---|---|
| Specific Gravity | 0.9204 | 0.7967 |
| Sulphur, ppm | Nil | Nil |
| Nitrogen, ppm | Nil | Nil |
| Cetane Index | | 75.6 |
| Total Acid Number | 19.2 | 0.05 |
| (mgKOH/g) | | |

ASTM D-86 (% Vol. vs. Temp (° C.))

| | |
|---|---|
| IBP | 163 |
| 5 | 196 |
| 10 | 216 |
| 20 | 245 |
| 30 | 261 |
| 40 | 274 |
| 50 | 284 |
| 60 | 293 |
| 70 | 302 |
| 80 | 313 |
| 90 | 332 |
| 95 | 355 |
| FBP (Final Boiling | 373 |
| Point) | |

Boiling range of neat Jatropha oil is 380° C.+ (Ref: Green Chemistry., 2010, 12, 2232-2239)

It can be seen that vegetable oil has been converted into diesel range hydrocarbons with high Cetane Index and low density. The high Cetane index and low density and zero sulphur will provide a scope of adding various low value streams in the refineries into diesel pool for meeting BS-IV and higher specification. Further, it has been found that the removal of oxygen from the feed predominantly occurs via hydrodeoxygenation/decarboxylation route. FT-IR spectra have shown no ester/acid functional group in the product thus confirms 100% conversion of triglycerides has occurred.

### EXAMPLE 4

### Catalyst Performance in a Blend of Jatropha Oil and Gas Oil

Experiments were conducted for co-processing of blends of Jatropha oil and gas oil with up to 20% with Jatropha oil. The operating conditions included H₂ partial pressure: 90 bar, Temperature: 370° C., LHSV: 1 hr⁻¹ and Gas to Oil ratio: 500 Nm³/m³. The results are shown in table 4.

TABLE 4
Properties of neat gas oil, products from neat gas oil, 5, 10 and 20% Jatropha oil with gas oil

| | | | Hydrotreated | Hydrotreated | Hydrotreated |
|---|---|---|---|---|---|
| | | Hydrotreated | Product (from 5% | Product (from 10% | Product (from 20% |
| | Feed | Product (from | Jatropha oil in | Jatropha oil in | Jatropha oil in |
| | (gas oil) | gas oil feed) | gas oil feed) | gas oil feed) | gas oil feed) |
| Specific | 0.8452 | 0.8146 | 0.8143 | 0.8136 | 0.8122 |
| gravity | | | | | |
| Sulphur | 13,600 | 30 | 15 | 5 | 3 |
| Nitrogen | 106 | 1 | 1 | 1 | 1 |
| Cetane Index | 51.5 | 62.4 | 63.1 | 64.4 | 66 |

ASTM D-86 (% Vol. vs. Temp(° C.)

| | | | | | |
|---|---|---|---|---|---|
| IBP | 182 | 137 | 143 | 147 | 142 |
| 5 | 213 | 176 | 182 | 183 | 185 |
| 10 | 230 | 198 | 202 | 206 | 208 |
| 20 | 253 | 227 | 231 | 236 | 238 |
| 30 | 267 | 248 | 250 | 255 | 257 |
| 40 | 279 | 261 | 264 | 267 | 270 |
| 50 | 289 | 273 | 275 | 278 | 280 |
| 60 | 300 | 284 | 286 | 288 | 290 |
| 70 | 312 | 297 | 297 | 299 | 301 |
| 80 | 326 | 312 | 312 | 313 | 312 |
| 90 | 345 | 333 | 333 | 333 | 331 |
| 95 | 363 | 353 | 353 | 354 | 355 |
| FBP | 374 | 362 | 364 | 367 | 370 |

The above results indicate that up to 20% Jatropha oil can be easily co-processed with gas oil using the developed catalyst. Further the results have shown that reduction in density and sulphur was occurred when Jatropha oil concentration was increased. Thus catalyst was found to have excellent catalytic activity for simultaneous elimination of sulphur and oxygen.

### EXAMPLE 5

### Comparative Analysis

A study was undertaken to compare the performance of the catalyst prepared in accordance with Example 1 with a commercially available catalyst which contained Co—Mo/Al₂O₃. The analysis was performed on two types of Feeds, wherein Feed 1 comprised of 10% Jatropha Oil in Gas Oil and Feed 2 comprised of 20% Jatropha Oil in Gas Oil. The operating conditions included H₂ partial pressure: 90 bar, Temperature: 370° C., LHSV: 1 hr⁻¹ and Gas to Oil ratio: 500 Nm³m/m³. The results are shown in Table 5.

TABLE 5
Comparative results

| | Hydrotreated | Hydrotreated | Hydrotreated | Hydrotreated |
|---|---|---|---|---|
| | products obtained | products obtained | products obtained | products obtained |
| | from Feed 1 using | from Feed 1 using | from Feed 2 using | from Feed 2 using |
| | commercial catalyst | catalyst of Ex. 1 | commercial catalyst | catalyst of Ex. 1 |
| Specific | 0.8194 | 0.8136 | 0.8184 | 0.8122 |
| gravity | | | | |
| Sulphur | 25 | 5 | 10 | 3 |
| Nitrogen | 1 | 1 | 1 | 1 |
| Cetane Index | 61.3 | 64.4 | 62.6 | 66 |

ASTM D-86 (% Vol. vs. Temp(° C.)

| | | | | |
|---|---|---|---|---|
| IBP | 127 | 147 | 125 | 142 |
| 5 | 174 | 183 | 178 | 185 |
| 10 | 195 | 206 | 201 | 208 |
| 20 | 226 | 236 | 229 | 238 |
| 30 | 253 | 255 | 256 | 257 |
| 40 | 267 | 267 | 271 | 270 |
| 50 | 279 | 278 | 283 | 280 |
| 60 | 290 | 288 | 292 | 290 |
| 70 | 302 | 299 | 305 | 301 |
| 80 | 315 | 313 | 318 | 312 |
| 90 | 340 | 333 | 343 | 331 |
| 95 | 368 | 354 | 368 | 355 |
| FBP | 375 | 367 | 370 | 370 |

It may be noted that Feed 1 had Density of 0.8527 g/cc; sulphur content of 11,900 ppm and nitrogen content of 95 ppm, while Feed 2 had Density of 0.8604 g/cc; sulphur content of 9000 ppm and nitrogen content of 85 ppm.

### EXAMPLE 6

### Catalyst Performance in a Blend of Karanjia Oil and Gas Oil

Experiments were conducted for co-processing of blended oil having 20 wt % Karanjia oil and the remaining being gas oil. The operating conditions included H₂ partial pressure: 90 bar, Temperature: 370° C., LHSV: 1 hr⁻¹ and Gas to Oil ratio: 500 Nm³/m³. The results are shown in table 6.

TABLE 6
Properties of 20% Karanjia oil with gas
oil and products obtained therefrom

| | 20% Karanjia in gas | Hydrotreated products of 20% |
|---|---|---|
| Characteristics | oil feed | Karanjia in gas oil |
| Density, g/cc | 0.8611 | 0.8127 |
| Sulphur, ppm | 9300 | 3 |
| Nitrogen, ppm | 85 | 1 |
| TAN, mg KOH/g | | 0.03 |
| Cetane Index | | 67 |

D-86 (% vol. vs. Temp(° C.)

| | |
|---|---|
| IBP | 163 |
| 5 | 236 |
| 10 | 250 |
| 20 | 262 |
| 30 | 271 |
| 40 | 279 |
| 50 | 287 |
| 60 | 295 |
| 70 | 304 |
| 80 | 315 |
| 90 | 338 |
| 95 | 364 |
| FBP | 370 |

### EXAMPLE 7

### Process for Preparing Catalyst having Nickel and Molybdenum Impregnated on Activated Carbon

Step 1: 4 gm of ammonium hepta molybdate (AHM) was dissolved in deionized water. The aqueous mixture from step 1 was poured onto around 10 gm of activated carbon taken in a beaker. The mixture was stirred well for 1 hr.

Step 2: About 2 gm of Nickel (II) Nitrate hexahydrate was dissolved in deionized water. The aqueous mixture of step 2 was added to the product material of step 1 and stirring was continued for 10-15 hrs, say 8 hrs.

Step 3: The impregnated material from step 2 was heated slowly in oven at 100-120° C. with heating rate of 0.3° C./min for 1-5 hrs, say 4 hrs.

Step 4: The dried material obtained from step 3 was heated in an inert atmosphere at 500° C. for 1 hr. The resulting material was referred as Nickel-Molybdenum/Activated Carbon supported Catalyst.

The detail of this catalyst is given below in Table 7.

TABLE 7
Final Ni—Mo/Carbon Catalyst properties

| Support material | Activated carbon |
|---|---|
| Active metals | Molybdenum, Nickel |
| BET Surface area, m²/g | 250 |

### EXAMPLE 8

### Ni—Mo/Carbon Catalyst's Performance in Jatropha Oil Blended with Gas Oil

The performance of the Ni—Mo/Carbon catalyst prepared in example 7 was studied for hydrotreating of Jatropha oil blended with gas oil. For doing so, two feeds namely a feed comprising 5 wt % Jatropha Oil blended with gas oil and a feed comprising 10 wt % Jatropha Oil blended with gas oil were taken. The operating conditions included H₂ partial pressure: 90 bar, Temperature: 370° C., LHSV: 1 hr⁻¹ and Gas to Oil ratio: 500 Nm³/m³. The results of the same are given in table 8.

TABLE 8
Hydrotreating properties of Ni—Mo/Carbon catalyst on Jatropha oil blended with gas oil

| | | Hydrotreated | | Hydrotreated |
|---|---|---|---|---|
| | | products of 5% | | products of 10% |
| | 5% Jatropha in | Jatropha in gas | 10% Jatropha in | Jatropha in gas |
| Characteristics | gas oil feed | oil | gas oil feed | oil |
| Density, g/cc | 0.8487 | 0.8230 | 0.8527 | 0.8225 |
| Sulphur, ppm | 12,900 | 25 | 11,900 | 10 |
| Nitrogen, ppm | 95 | 1 | 95 | 1 |
| TAN, mg KOH/g | | | | |
| Cetane Index | | 59.2 | | 59.8 |
| D-86 (% vol. vs. Temp(° C.) | | | | |
| IBP | | 155 | | 112 |
| 5 | | 207 | | 206 |
| 10 | | 226 | | 223 |
| 20 | | 244 | | 244 |
| 30 | | 257 | | 256 |
| 40 | | 267 | | 268 |
| 50 | | 277 | | 279 |
| 60 | | 288 | | 288 |
| 70 | | 300 | | 300 |
| 80 | | 314 | | 313 |
| 90 | | 335 | | 335 |
| 95 | | 356 | | 363 |
| FBP | | 363 | | 370 |

### EXAMPLE 9

### Comparative Analysis

A study was undertaken to compare the performance of the catalyst prepared in accordance with Example 1 and the catalyst prepared in accordance with Example 7 with a commercially available catalyst which contained Co—MO/Al₂O₃. The analysis was performed on pure Jatropha oil feed. The operating conditions included H₂ partial pressure: 90 bar, Temperature: 370° C., LHSV: 1 hr⁻¹ and Gas to Oil ratio: 500 Nm³/m³. The results are shown in Table 9.

TABLE 9
Comparative Results

| | | Hydrotreated Jatropha oil | | |
|---|---|---|---|---|
| | Pure Jatropha | Commercial | Inventive | Inventive |
| Characteristics | oil feed | Co—Mo/Al₂O₃ | Co—Mo/Carbon | Ni—Mo/Carbon |
| Density, g/cc | 0.9204 | 0.7990 | 0.7967 | 0.7993 |
| Sulphur, ppm | NIL | NIL | NIL | NIL |
| Nitrogen, ppm | NIL | NIL | NIL | NIL |
| TAN, mg KOH/g | 24 | 0.05 | 0.05 | 0.05 |
| Cetane Index | | 78.7 | 75.6 | 77.1 |
| D-86 (% vol. vs. Temp(° C.) | | | | |
| IBP | | 141 | 163 | 144 |
| 5 | | 251 | 196 | 259 |
| 10 | | 271 | 216 | 275 |
| 20 | | 286 | 245 | 282 |
| 30 | | 292 | 261 | 289 |
| 40 | | 295 | 274 | 293 |
| 50 | | 300 | 284 | 295 |
| 60 | | 304 | 293 | 298 |
| 70 | | 306 | 302 | 301 |
| 80 | | 310 | 313 | 307 |
| 90 | | 335 | 332 | 333 |
| 95 | | 356 | 355 | 350 |
| FBP | | 372 | 373 | 372 |

While the present invention has been described and illustrated by reference to particular embodiments, those of ordinary skill in the art will appreciate that the invention lends itself to variations not necessarily illustrated herein. For this reason, then, reference should be made solely to the appended to claims for purposes of determining the true scope of the present invention.

We claim:

1. A hydrotreating catalyst comprising:
a non-refractory oxide catalyst support;
a Group VIB metal impregnated on the support; and
a Group VIII metal impregnated on the support;
characterized in that:
the support comprises porous activated carbon;
an amount of Group VIB metal impregnated on the support is in the range of 10 to 18 wt % based on a total weight of the finished catalyst composition; and
an amount of Group VIII metal impregnated on the support is in the range of 0.1 to 5.0 wt % based on a total weight of the finished catalyst composition.

2. The hydrotreating catalyst as claimed in claim 1, wherein the Group VIB metal is Molybdenum.

3. The hydrotreating catalyst as claimed in claim 1, wherein the Group VIII metal is Cobalt or Nickel.

4. The hydrotreating catalyst as claimed in claim 1, wherein the catalyst further comprises 0.1 to 5.0 wt % of a Group IIIA element impregnated on the support.

5. The hydrotreating catalyst as claimed in claim 4, wherein Group IIIA element is Phosphorous.

6. The hydrotreating catalyst as claimed in claim 1, wherein an amount of porous activated carbon is in the range of 70 to 85 wt % based on a total weight of the finished catalyst composition.

7. The hydrotreating catalyst as claimed in claim 1, wherein the catalyst has a BET surface area in the range of 50 to 300 m²/g.

8. The hydrotreating catalyst as claimed in claim 1, wherein the catalyst has average pore diameter is in the range of 12 to 100 Å.

9. The hydrotreating catalyst as claimed in claim 1, wherein the catalyst has pore volume in the range of 0.3 to 1.4 cc/g.

10. A process for preparing a hydrotreating catalyst, said process comprising the steps of:
impregnating a non-refractory oxide catalyst support with an aqueous solution comprising a source of Group VIB metal and a source of Group VIII metal to obtain wet impregnated support;
drying the wet-impregnated support for about 1 to 5 hours at a temperature in the range of about 100 to 120° C. to obtain impregnated support; and
calcining the impregnated support at a temperature in the range of about 500 to 600° C. for a time period in the range of about 1 to 5 hours to obtain the hydrotreating catalyst;
characterized in that:
support comprises porous activated carbon;
an amount of Group VIB metal source present in the aqueous solution is such that 10 to 18 wt % of the Group VIB metal based on a total weight of the finished catalyst composition is incorporated in the support; and
an amount of Group VIII metal source present in the aqueous solution is such that 0.1 to 5.0 wt % of the Group VIII metal based on a total weight of the finished catalyst composition is incorporated in the support.

11. The process as claimed in claim 10, wherein the Group VIB metal is Molybdenum.

12. The process as claimed in claim 11, wherein the source of Group VIB metal is ammonium heptamolybdenum.

13. The process as claimed in claim 10, wherein the Group VIII metal is Cobalt or Nickel.

14. The process as claimed in claim 13, wherein the source of Group VIII metal is selected from the group comprising of cobalt nitrate hexahydrate and Nickel (II) Nitrate hexahydrate.

15. The process as claimed in claim 10, wherein the aqueous solution further comprises a Group IIIA element source, an amount of Group IIIA element source present in the aqueous solution is such that 0.1 to 5.0 of the Group IIIA element based on a total weight of the finished catalyst composition is incorporated in the support.

16. The process as claimed in claim 15, wherein the Group IIIA element is Phosphorous.

17. The process as claimed in claim 15, wherein the Group IIIA element source also acts as Group VIB metal source.

18. The process as claimed in claim 17, wherein the Group IIIA element source acting as Group VIB metal source is Phosphomolybdic acid.

19. The process as claimed in claim 10, wherein the porous activated carbon has:
a. BET surface area in the range of 500 to 1500 (1500) m²/g;
b. Bulk density in the range of 0.3 to 0.7 g/cc;
c. Average pore diameter is in the range of 12 to 100 Å; and
d. Pore volume in the range of 0.3 to 1.4 cc/g.

20. A process for producing diesel range hydrocarbons from a feed comprising vegetable oil and or vegetable oil with gas oil said process comprising the steps of:
a. contacting the feed within a hydrotreatment reaction zone with a gas comprising hydrogen under hydrotreatment conditions in presence of a hydrotreating catalyst comprising a non-refractory oxide catalyst support, a Group VIB metal impregnated on the support and a Group VIII metal impregnated on the support;
b. removing a hydrotreated product stream; and
c. separating diesel range hydrocarbons from the hydrotreated product stream
characterized in that:
the support comprises porous activated carbon;
an amount of Group VIB metal impregnated on the support is in the range of 10 to 18 wt % based on a total weight of the finished catalyst composition; and
an amount of Group VIII metal impregnated on the support is in the range of 0.1 to 5.0 wt % based on a total weight of the finished catalyst composition.

21. The process as claimed in claim 20, wherein the vegetable oil is selected from a group comprising of Jatropha Oil, Karanjia Oil, Rubber seed oil, Cotton Seed oil, waste restaurant oil and or mixtures thereof.

22. The process as claimed in claim 20, wherein the feed comprises a mixture of vegetable oil and gas oil with up to about 20 wt % of vegetable oil.

23. The process as claimed in claim 20, wherein the hydrotreatment in step (a) is carried out at a temperature from about 350° C. to about 400° C.

24. The process as claimed in claim 20, wherein the hydrotreatment reaction zone has an LHSV from 0.5 hr ⁻¹ to 2 hr⁻¹.

25. The process as claimed in claim 20, wherein the hydrotreatment reaction zone has hydrogen partial pressure from about 60 bar to about 120 bar.

26. The process as claimed in claim 20, wherein the hydrotreatment reaction zone has H₂ gas to feed ratio from about 400 Nm³/m³ to 600 Nm³/m³.

27. The process as claimed in claim 20, wherein the Group VIB metal is Molybdenum.

28. The process as claimed in claim 20, wherein the Group VIII metal is Cobalt or Nickel.

29. The process as claimed in claim 20, wherein the catalyst further comprises 0.1 to 5.0 wt % of a Group IIIA element impregnated on the support.

30. The process as claimed in claim 29, wherein the Group IIIA element is Phosphorous.

31. The process as claimed in claim 20, wherein an amount of porous activated carbon is in the range of 70 to 85 w 5% based on a total weight of the finished catalyst composition.

32. The process as claimed in claim 20, wherein the catalyst has a BET surface area in the range of 50 to 300 m²/g.

33. The process as claimed in claim 20, wherein the catalyst has average pore diameter is in the range of 12 to 100 Å.

34. The process as claimed in claim 20, wherein the catalyst has pore volume in the range of 0.3 to 1.4 cc/g.
